(19) United States
(12) Patent Application Publication
(10) Pub. No.: US 2025/0196264 A1
(43) Pub. Date: Jun. 19, 2025

(54) WIRE GUIDE DEVICE FOR A LASER PROCESSING HEAD FOR DEPOSITION WELDING AND LASER PROCESSING HEAD FOR DEPOSITION WELDING COMPRISING THE WIRE GUIDE DEVICE

(71) Applicant: Precitec GmbH & Co. KG, Gaggenau (DE)

(72) Inventors: Steffen Boley, Leonberg (DE); Felicitias Kunz, Karlsruhe (DE)

(73) Assignee: Precitec GmbH & Co. KG, Gaggenau (DE)

(21) Appl. No.: 18/938,872

(22) Filed: Nov. 6, 2024

(30) Foreign Application Priority Data
Dec. 14, 2023 (DE) 20 2023 107 402.2

(51) Int. Cl. B23K 26/342

(52) U.S. Cl. CPC B23K 26/342

(57) ABSTRACT

A wire guide device for a laser processing head for deposition welding by a laser beam has a plurality of guide parts arranged in succession to guide a welding wire. Two of the guide parts are movably coupled to each other by a coupling element. A second guide part of the two guide parts is displaceable and/or tiltable relative to a first guide part of the two guide parts.

### CROSS REFERENCE OF RELATED APPLICATION

This application claims priority to German Patent Application No. 20 2023 107 402.2, filed Dec. 14, 2023, which is hereby incorporated by reference in its entirety.

### FIELD OF THE INVENTION

The present invention relates to a wire guide device for a laser processing head, in particular a laser welding head, for deposition welding and a laser processing head for deposition welding comprising the wire guide device. In particular, the present invention relates to a wire guide device with multiple guide parts which are movably coupled to each other.

### BACKGROUND OF THE INVENTION

Laser deposition welding (‘deposition welding’ for short) is an additive manufacturing method in which a deposition material, for example as a wire, is melted by means of a laser beam and connected to at least one workpiece. A laser welding head shines a laser beam emitted from a laser source or one end of a laser guide fibre onto a processing zone on the workpiece. A wire guide device guides the wire (also known as welding wire) to the processing zone. The wire guide device can be arranged on or in the laser processing head.

The wire guide device must be protected against collisions with other objects, for example with the workpiece itself or with other elements of a laser deposition welding system. Collisions can be regarded as unintentional contact between the wire guide device with other objects, in particular the workpiece surface. The protection is required to protect the wire guide device and laser welding head from damage due to collisions. Conventional solutions for collision protection provide a predetermined breaking point on the wire guide device, which breaks in the event of a collision and protects other elements of the laser welding head or the wire guide device from damage.

The disadvantage of this solution is that the predetermined breaking point has to be replaced after a collision. This replacement generates costs and requires time during which the laser welding head cannot be used. In addition, conventional wire guide devices do not allow any adjustment, in particular no adjustment of the wire guide direction and/or the wire orientation at or in the processing zone.

### SUMMARY OF THE INVENTION

It is a task to provide an improved wire guide device for a laser processing head for deposition welding and a laser processing head with such a wire guide device. In particular, it is a task of the invention to disclose a wire guide device with improved collision protection.

It is further a task to provide a wire guide device for a laser processing head for deposition welding and a laser processing head with such a wire guide device which allows an adjustment, in particular an adjustment of a wire guide direction, a wire feed position and/or a wire orientation.

The present invention is based on the realisation that a predetermined breaking point does not provide non-destructive collision protection, but that the wire guide must be replaced after a collision. Furthermore, the present invention is based on the realisation that conventional wire guide devices are formed as a rigid component, i.e. a component in which all elements are fixedly connected to one another.

The present invention is based on the basic idea that a wire guide device can be provided with (at least) two guide parts for the welding wire which can be releasably coupled to each other and/or are movable relative to each other. In the event of a collision, the collided part can release itself from the other part or deflect or displace itself with respect to the other part in order to prevent damage to the workpiece and/or the wire guide. In particular, an element with a predetermined breaking point can be replaced by two guide parts for the welding wire that are releasably and/or movably coupled to each other. In the event of a collision, the guide parts can therefore move relative to each other without a break, i.e. irreversible separation or destruction, having to take place. After the collision, the two guide parts can be realigned or coupled together again. The welding wire can be easily tracked and the bent area of the welding wire caused by the relative movement or reversible separation of the guide parts can be separated from the rest of the welding wire. Deposition welding can then be resumed immediately. The time during which deposition welding is interrupted by the collision can thus be significantly reduced. In addition, costs for replacing (parts of) the wire guide, e.g. the element with the predetermined breaking point, can be omitted. Collision protection is done in a non-destructive manner.

At least one of the tasks is solved by the subject matter disclosed herein. Advantageous embodiments and further embodiments are also disclosed.

According to a first aspect of the present disclosure, a wire guide device for a laser processing head for deposition welding by means of a laser beam is disclosed. The wire guide device comprises multiple guide parts arranged in succession to guide a welding wire. Two of the multiple guide parts are movably coupled to each other by a coupling element, wherein one guide part is displaceable and/or tiltable relative to the other guide part. Preferably, a second guide part can be displaceable and/or tiltable and/or releasable relative to the first guide part. The first guide part can be fixedly arranged with respect to a beam propagation direction of the laser beam and/or with respect to a predetermined wire guide direction. For example, the first guide part can be attached to the laser processing head, preferably on the outside of a housing of the same.

The guide parts may be arranged one behind the other along a wire guide direction and/or along the longitudinal axes of the guide parts and/or along the beam propagation direction.

According to a second aspect of the present disclosure, there is disclosed a laser processing head for deposition welding by means of a laser beam, comprising a wire guide device according to aspects of the present disclosure.

The aspects of the present disclosure may have one or multiple of the following optional features.

A displacing or ‘displaceable’ means a translational movement along a direction, a tilting or ‘tiltable’ means a rotational movement about an axis of rotation, in particular an axis of rotation perpendicular to one or both longitudinal axes of the guide parts. ‘With respect to’ means relative to each other. Parts ‘movably coupled to each other’ means that the parts have a defined orientation relative to each other in a rest position, but can move relative to each other into a deflected position, i.e. in particular tilt and/or displace and/or release. Holding in the rest position can be effected by the coupling device. The movement can be caused by an external force acting on at least one of the guide parts, for example by contact between this guide part and another object. The parts can be arranged adjacent to each other in the rest position and can be released from each other during movement. By ‘releasable’ in the present disclosure is meant ‘reversibly releasable’. ‘Move relative to each other’ may mean displaceable relative to each other and/or tiltable relative to each other. Alignment relative to each other also includes the position relative to each other.

The multiple guide elements may be arranged to guide the welding wire along a predetermined wire guide direction. Each of the guide parts may have a channel for guiding the welding wire (guide channel). Each of the guide parts can be arranged and/or formed in such a way that the guide channel of the respective guide element extends along a predetermined wire guide direction. The guide channels of the multiple guide parts may be arranged concentrically and/or in alignment with each other, in particular in the rest position. In other words, the guide parts of the wire guide can be arranged coaxially to one another in the rest position or target position. The tilting and/or displacement of the guide parts relative to one another can mean that the longitudinal axes of the guide parts tilt and/or displace relative to one another. A longitudinal axis of a guide part can be defined as a centre line of the guide part and/or the guide channel of the guide part. The longitudinal axis of a guide part can correspond to an axis of symmetry of the guide part. The tilt and/or displacement of the second guide part can alternatively or additionally also be relative to the beam propagation direction of the laser beam.

The coupling element can be arranged to couple the two guide parts to each other movably, in particular releasably, using a holding force, in particular a magnetic force and/or a spring force. The magnetic force can also be referred to as a magnetic holding force. The spring force can also be referred to as an elastic restoring force. Thus, the holding force can hold the two guide parts in the rest position. This can provide a technically simple and cost-effective way of holding the two guide parts in the rest position. The holding force can be selected such that contact or collision of the second guide part with an object, for example a workpiece or another element, causes the second guide part to be released from the first guide part and to tilt and/or displace relative to the first guide part. The contact can occur, for example, when the laser processing head with the wire guide device is moved relative to the workpiece. The holding force can be selected so that it is greater than a weight force of the second guide part and any elements arranged or attached thereto, such as an intermediate pipe and/or a wire nozzle. In particular, a magnetic and/or elastic frictional connection between the two guide parts can be provided by the coupling device.

The coupling element can comprise at least one magnet which is arranged on one, on the first or on the second, of the two guide parts, in particular attached thereto, and which is arranged to couple the two guide parts movably and/or releasably to one another. The wire guide device or at least one of the guide parts thereof may consist of or comprise a ferromagnetic material, in particular magnetic stainless steel. In particular, the other, the second or the first, of the two guide parts may comprise the ferromagnetic material. In this way, the magnetic force for coupling the two guide parts can be provided in a simple manner. The magnet can exert the magnetic force on the two guide elements.

The at least one magnet can be formed rotationally symmetrically and/or as a ring magnet. Alternatively or additionally, the coupling element can comprise multiple magnets that are arranged symmetrically, in particular rotationally symmetrically, to the longitudinal axis of the first guide part and/or the second guide part and/or to a beam propagation direction of the laser beam. This can ensure that contact guides the guide parts towards each other in a direction-independent and uniform manner, thereby ensuring reliable collision protection.

The coupling element can comprise a pot-shaped area. The pot-shaped area can be attached to the first or second guide part, depending on which guide part the magnet is attached to. The magnet may be disposed within the pot-shaped area and/or attached to the pot-shaped area. In other words, the coupling element may be formed as a pot-shaped magnet.

A part of the wire guide device may be formed integrally with the coupling element or a part thereof. For example, the second guide part may be formed integrally with the coupling element, in particular with the pot-shaped area.

The at least one magnet can maintain the magnetic force even at a temperature of more than 100° C., for example at 200° C. The at least one magnet may comprise samarium and/or cobalt or consist of or comprise a samarium-cobalt alloy. This can ensure that the magnet maintains its magnetic force even at high temperatures, such as those generated during laser deposition welding at the processing zone on the workpiece.

Alternatively or additionally, the coupling element can comprise at least one spring. The at least one spring can be connected to each of the two guide parts. The at least one spring can movably couple the two guide parts to one another in a movable manner, i.e. in particular tiltably and/or displaceably and/or releasably. The at least one spring can be formed as a helical spring, in particular a pressure helical spring, or as a leaf spring. For example, if the helical spring is used, one end of the helical spring can be connected to the first guide part and the second end of the leaf spring can be connected to the second guide part. The spring can exert the spring force on the two guide members.

The wire guide device may further comprise an adjusting device for adjusting or setting a wire feed position and/or wire guide direction and/or wire direction. The adjusting device may be arranged to displace one of the at least two guide parts relative to the other of the two guide parts in a plane perpendicular to the wire guide direction and/or perpendicular to the longitudinal axis of the guide part and/or of the second guide part and/or perpendicular to the beam propagation direction of the laser beam. Preferably, the adjusting device can displace the second guide part relative to the first guide part. By means of the adjusting device, an adjustment of the channel for guiding the welding wire and thus a position of the wire (wire feed position), in particular a position of the wire with respect to the laser processing head or with respect to the laser beam, can be provided. In particular, a position and/or orientation of the channel or the wire feed can be adjusted. In particular, the setting can be used to ensure that the wire is always guided to the processing zone along the predetermined wire guide direction, in particular concentrically to the laser beam, and/or coincides with the laser beam at a predetermined point. In particular, the adjusting device can be used to fine-tune the wire feed position.

The adjusting device can have a first adjusting unit and a second adjusting unit. The first adjusting unit can be arranged to displace one of the two guide parts, in particular the second guide part, relative to the other guide part, in particular the first guide part, along a first direction in the plane. The second adjusting unit can be arranged to displace one guide part relative to the other guide part along a second direction in the plane. The first direction and the second direction may preferably be perpendicular to each other. This allows flexible adjustment of the wire guide direction.

The adjusting device, in particular each of the first adjusting unit and the second adjusting unit, may comprise a screw, a bolt and/or a spring. By means of these elements, a technically simple and easy-to-operate adjustment can be realised.

The wire guide device may further comprise an intermediate pipe, wherein a first end is arranged or attached to the second guide part. A wire nozzle may be arranged or attached at the other end of the intermediate pipe. Alternatively, the wire nozzle may be attached directly to the second guide part. The intermediate pipe and/or the wire nozzle may also be formed for guiding the welding wire, and may also have a channel for guiding the welding wire. The wire nozzle may be arranged for discharging the welding wire from the wire guide device.

The intermediate pipe may be made of metal, in particular copper, or may be comprised metal, in particular copper. The wire nozzle may be made of metal, in particular copper, or may be comprised of metal, in particular copper. The wire guide device may further have an insulation part between the second guide part and the intermediate pipe, or between the intermediate pipe and the wire nozzle. The insulating part can be a ceramic part. Ceramic is used to thermally insulate the other components of the wire guide device and the laser processing head from the temperatures at the processing zone on the workpiece. The wire nozzle and/or the insulation part can be formed to be removable from the intermediate pipe or the second guide part. For example, the wire nozzle and/or the insulation part can be screwed on and off the intermediate pipe or the second guide part.

The laser processing head can also comprise a detection device that is arranged to detect a movement, in particular a displacement and/or a tilt, of the second guide part relative to the first guide part and/or relative to the beam propagation direction. A collision of the wire guide device can be detected by the detection device. The collision can be detected effectively and reliably because the detection is always carried out via the movable second guide part relative to the first guide part. The detection device can comprise a light generating device arranged to generate a detection beam and to shine the detection beam onto the second guide part, and a light receiving device arranged to receive and detect a portion of the detection beam reflected by the second guide part. The beam may be a detection laser beam. Based on the detected portion of the detection beam, the movement of the second guide part can be detected.

The laser processing head can be arranged to shine the laser beam on a processing zone on the workpiece. The laser processing head can have at least one optical element for beam guidance and/or beam shaping. In particular, the laser processing head can comprise focussing optics for focussing the laser beam on the workpiece. In addition, the laser processing head can comprise collimating optics for collimating the laser beam. In addition, the laser processing head can comprise at least one further optical system, for example an axicon and/or a prism, for forming an annular laser beam and/or for concentrically shining the laser beam with the welding wire at the processing zone on the workpiece.

### BRIEF DESCRIPTION OF THE DRAWINGS

Embodiments of the present disclosure are illustrated with reference to the figures and are described in detail below.

FIG. 1 is a schematic view of a laser processing head with a wire guide device according to embodiments of the present disclosure;

FIG. 2A is a schematic view of a wire guide device according to embodiments of the present disclosure in a rest position;

FIG. 2B is a schematic view of a wire guide device according to embodiments of the present disclosure with a second guide part in a deflected position;

FIG. 3 is a schematic sectional view of a wire guide device according to further embodiments of the present disclosure;

FIG. 4 is a schematic sectional view of an adjusting device of a wire guide device according to embodiments of the present disclosure;

FIG. 5 is a schematic sectional view of a coupling device of a wire guide device according to embodiments of the present disclosure; and

FIG. 6 is a schematic view of a laser processing head with a wire guide device according to further embodiments of the present disclosure.

### DETAILED DESCRIPTION OF THE INVENTION

In the following, unless otherwise indicated, the same reference signs are used for identical and similarly acting elements.

The directions x, y and z shown in the figures are coordinate axes of a Cartesian coordinate system. A direction along the z direction can be referred to as a vertical direction and a direction along the x or y direction can be referred to as a horizontal direction.

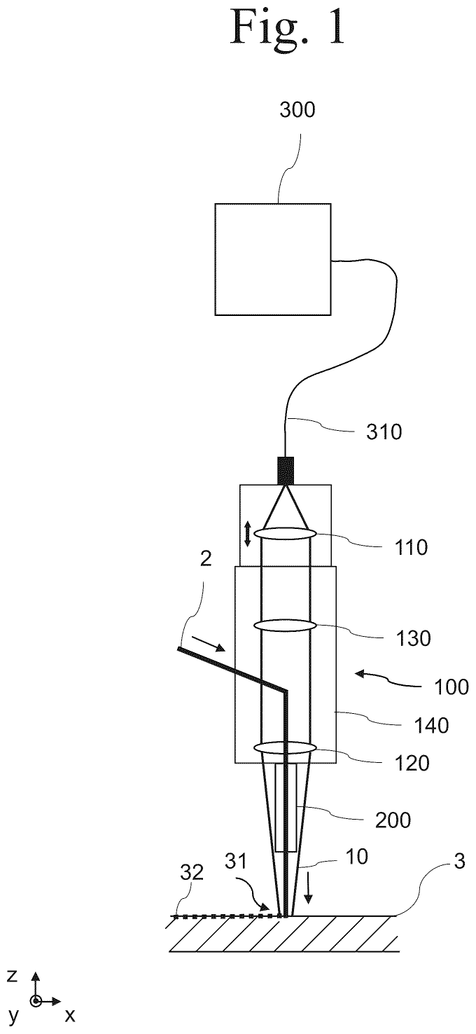

FIG. 1 shows a schematic view of a laser processing head with a wire guide device according to embodiments of the present disclosure.

The laser processing head 100 is used in particular for deposition welding by means of a laser beam (laser deposition welding), and can therefore also be referred to as a laser welding head. In laser deposition welding, deposition material is guided as a wire 2 to a processing zone 31 on a workpiece 3. The wire guiding is done along a predetermined wire guide direction, which can change along the welding wire 2. In FIG. 1, the wire guide direction runs in a vertical direction in an area of the welding wire 2 after exiting a housing 140 of the laser processing head 100 and in front of the processing zone 31. At the same time, a laser beam 10 is shone into the processing zone 31. This melts the fed wire and connects it to the workpiece 3. By moving the processing zone 31, for example by moving the laser processing head 100 along a feed direction, which can be a horizontal direction, a weld seam 32 is created. The weld seam 32 can be used to connect multiple workpieces.

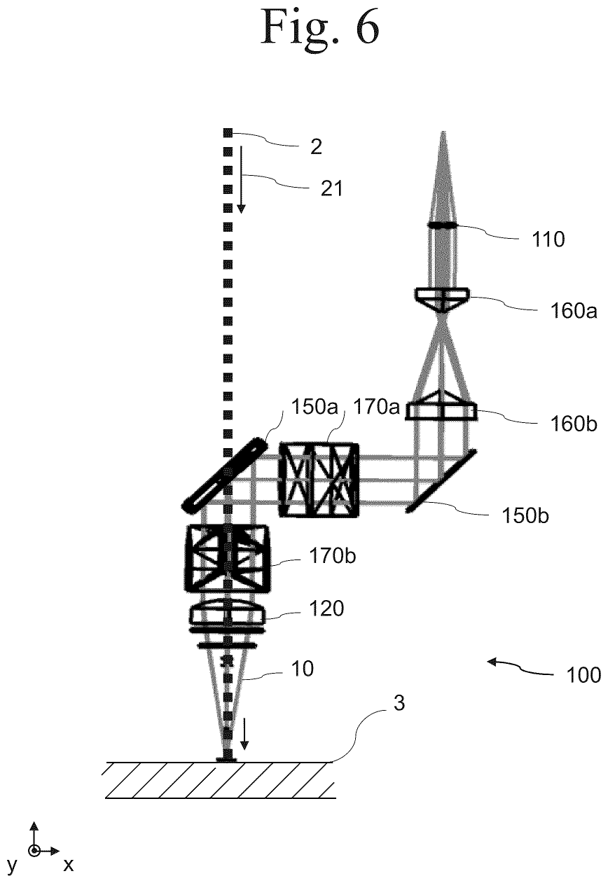

FIG. 6 shows an embodiment of a laser processing head 100 with a straight guide for the welding wire 2. The wire guide device 200 is not shown in FIG. 6. In this case, the beam path of the laser beam 10 is angled or bent or folded. The laser beam 10 is reflected at two mirrors 150a, 150b. After collimation by collimation optics 110, the laser beam 10 is formed into an annular shape by at least one axicon 160a, 160b. In particular, a cross-section of the laser beam 10 is formed in an annular shape in a plane perpendicular to the beam propagation direction by at least one axicon 160a, 160b. The laser beam 10 is then reflected at the mirror 150b. The laser beam 10 is then split into multiple parts, for example 2 or 4, in a plane perpendicular to the beam propagation direction by a first prism 170a. The parts of the laser beam 10 are guided around the welding wire 2 with the aid of the mirror 150a and then reunited to form an annular laser beam by means of a second prism 170b. ‘Annular’ can also mean that the laser beam 10 has a rotationally symmetrical, in particular a rotationally symmetrical, shape with respect to the beam propagation direction.

To guide the welding wire 2 to the processing zone 31, a wire guide device 200 according to embodiments of the present disclosure is provided. The wire guide device 200 serves to ensure that the welding wire 2 is guided to the processing zone 31 substantially along the predetermined wire guide direction. To this end, the welding wire 2 is guided by the wire guide device until shortly before it reaches the processing zone 31. The wire guide device 200 may be arranged or attached to the housing 140 of the laser processing head 100, for example at a lower end. Preferably, the wire guide device 200 is arranged with respect to the propagation direction of the laser beam 10 after the last optical element, for example a focussing optics 120, or after the last protective glass (not shown), but the present disclosure is not limited thereto. According to embodiments that are also not limiting, and as shown in FIG. 1, the welding wire 2 may first pass through the laser processing head 100 before the welding wire 2 exits the laser processing head 100 and enters the wire guide device 200. The wire guide device 200 will be described in detail below.

In addition, a laser source 300 may be provided for generating the laser beam 10. The laser source 300 emits a laser beam 10 (processing beam), which is fed to the laser processing head 100 through an optical fibre 310.

The laser processing head 100 is used to shine the laser beam 10 onto the workpiece 3. The laser processing head 100 may have one or multiple optical elements, for example lenses, objectives, mirrors, prisms, axicons, etc. The optical elements are used for beam guidance and shaping. The optical elements may have transmitting and/or reflecting optical elements. For example, the laser processing head 100 has collimating optics 110, focussing optics 120, and zoom optics or a zoom lens (not shown). The optical elements can be used, for example, to set a focus position and/or focus position and a focus diameter of the laser beam 10.

In addition, the laser processing head 100 may have optical elements 130, for example axicons and prisms, for generating an annular laser beam 10. The laser processing head 100 may also be arranged to guide the laser beam 10 coaxially to the predetermined wire guide direction of the welding wire 2, at least in sections. This means that the beam propagation direction and the wire guide direction of the welding wire 2 are at least partially coaxial with each other and/or coincide. In particular, the laser beam 10 can be shone onto the processing zone 31 coaxially with the welding wire 2. The optical elements 130 are exemplarily illustrated in FIG. 1 as a single optical element, however, the present disclosure is not limited thereto.

Furthermore, a traversing device (not shown) may be provided which is arranged to set a position of the laser processing head 100 relative to the workpiece 3, in particular to move the laser processing head 100 along the feed direction. The workpiece 3 or the workpieces can be formed as a plate-shaped and/or metallic workpiece.

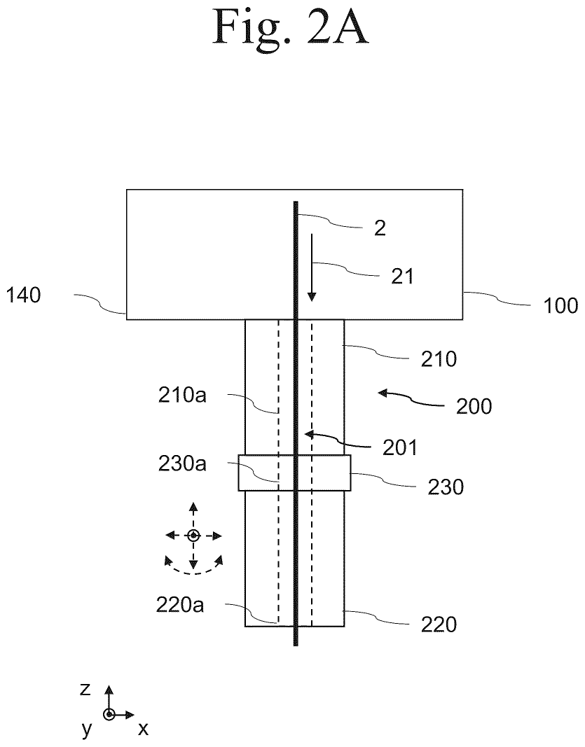

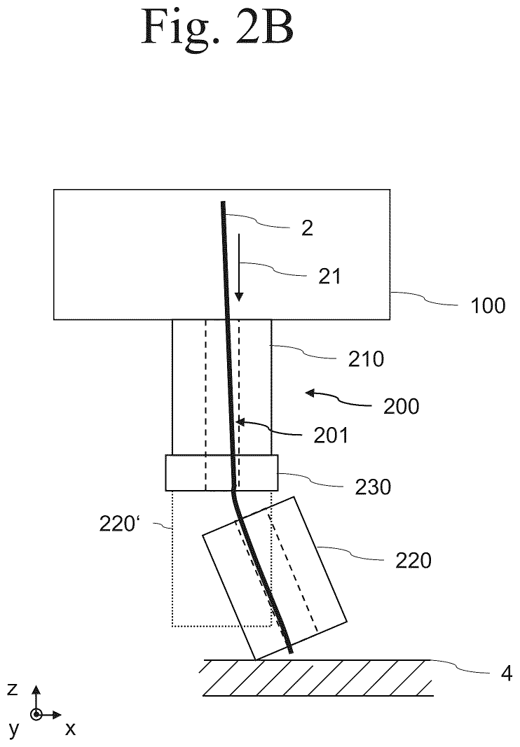

FIG. 2A shows a schematic view of a wire guide device according to embodiments of the present disclosure.

The wire guide device 200 is arranged at a lower end of a housing 140 of the laser processing head 100. The welding wire 2 exits the housing 140 and then enters the wire guide device 200 at a first end, for example an upper end, and passes through the wire guide device 200. The welding wire then exits at a second end opposite the first end, for example a lower end. By passing through the wire guide device 200, the welding wire 2 is guided along a predetermined wire guide direction 21. The welding wire 2 then enters the processing zone on the workpiece (not shown in FIG. 2A). The wire guide device 200 has a channel 201 through which the welding wire 2 is guided. The channel 201 can be formed straight and directed towards the processing zone.

The wire guide device 200 has multiple guide parts 210, 220. In FIG. 2A, two guide parts 210, 220 are shown, but the present disclosure is not limited thereto. There may be more than two guide parts, for example three or four. Furthermore, each of the guide parts may in turn comprise multiple elements or parts.

The guide parts 210, 220 are arranged one behind the other along the wire guide direction 21 and/or along a beam propagation direction of the laser beam (not shown in FIG. 2). Each of the guide parts 210, 220 serves to guide the welding wire 2. For this purpose, each of the guide parts 210, 220 has a respective guide channel 210a, 220a. Each of the guide channels 210a, 220a extends along the predetermined wire guide direction 21. A guide channel 210a, 220a can define the longitudinal axis of the respective guide part 210, 220. In particular, the longitudinal axes may be defined by a centre line of the channels 210a, 220a. Thus, the guide parts 210, 220 are arranged such that their longitudinal axes run along the wire guide direction 21 or along the beam propagation direction.

The two guide parts 210, 220 are movably coupled to each other by a coupling element 230. One guide part is displaceable and/or tiltable relative to the other guide part. The coupling element 230 may have a guide channel 230a analogous to the guide parts 210, 220. Each of the channels 210a, 220a of the guide parts and possibly the guide channel 230a of the coupling element 230 can form a portion of the channel 201 of the wire guide device 200.

The displacement and tilting are illustrated in FIG. 2A using the dashed double arrows. For example, the first guide part 210 is attached to the housing 140 of the laser processing head 100 and the second guide part 220 is displaceable and/or tiltable relative to the first guide part 210 by means of the coupling element 230. The second guide part 220 can be displaced along and/or perpendicular to the longitudinal direction of the first guide part 210. For example, in FIG. 2A, the second guide part 220 can be displaced along each of the spatial directions x, y, z. Furthermore, the tilt can be about an axis of rotation that lies in a plane perpendicular to the longitudinal direction. In FIG. 2A, this plane may comprise the spatial directions x and y.

The two guide parts 210, 220 are held in a defined rest position relative to each other by the coupling element 230. The rest position is shown in FIG. 2A. From this rest position, the second guide part 220 can be deflected relative to the first guide part 210 by displacement and/or tilt. FIG. 2B shows a deflected position of the second guide part 220. The deflection can be caused, for example, by unintentional contact with another element 4, for example a workpiece, of the second guide part 220. The other element 4 exerts a force on the second guide part 220, which deflects it from the rest position, illustrated in FIG. 2A by the reference sign 220′. The movement of the second guide part 220 can be detected by a detection device (not shown) of the laser processing head 100. If such a movement is detected, a movement of the laser processing head 100 can be stopped or the laser processing head 100 can be moved to a secure starting position. The second guide part 220 can then be returned to the rest position and the portion of the welding wire 2 that was bent by the movement of the second guide part 220 can be separated from the rest. The deposition welding can then be continued.

The coupling element 230 can be arranged to couple the two guide parts 210, 220 to each other in a movable manner using a magnetic force and/or a spring force. In particular, a magnetic and/or elastic frictional connection between the two guide parts 210, 220 may be provided by the coupling device 230. Corresponding embodiments of the present disclosure are described in detail below.

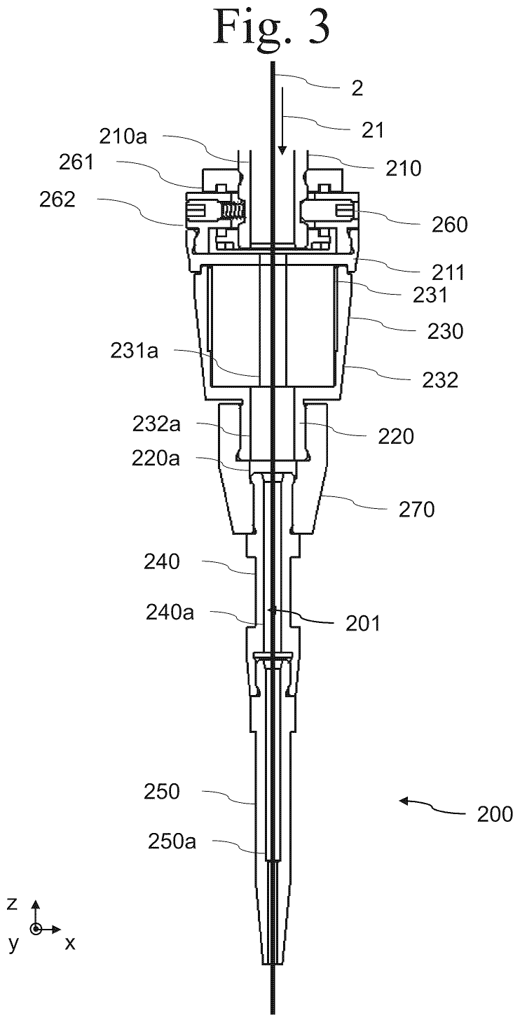

FIG. 3 a schematic sectional view of a wire guide device according to further embodiments of the present disclosure. The wire guide device may be, for example, the wire guide device 200 of FIGS. 1 and 2.

Here, the coupling element 230 comprises a magnet 231. The magnet 231 is formed substantially rotationally symmetrical and/or annular. The magnet 231 can be formed from a samarium-cobalt alloy. The magnet 231 comprises a channel 231a for guiding the welding wire (not shown). The channel 231a forms a portion of the channel 230a or the channel 201. The magnet 231 is attached to the second guide part 220, for example by screws or adhesive. The first guide part 210 is formed from a ferromagnetic material, for example a magnetic stainless steel. The holding force exerted by the magnet 231 on the magnetic material allows the two guide parts 210, 220 to be movably and releasably coupled together. This effect is also already achieved when at least one part 211 of the wire guide device 200, which is opposite the magnet 231, is formed from the ferromagnetic material, wherein the part 211 is fixedly connected to the first guide part 210. In particular, the magnet 231 and the first guide part 210 or the part 211 may contact each other in a plane perpendicular to the longitudinal axis of the guide parts.

The coupling element 230 further comprises a pot-shaped area 232. The pot-shaped area 232 is attached to the second guide part 220. In particular, the area 232 may be integrally formed with the second guide part 220 as shown. The magnet 231 is arranged in the pot-shaped area 232 or inserted into the area 232 and attached to the pot-shaped area 232. The pot-shaped area 232 may also be formed from a ferromagnetic material such as magnetic stainless steel. This results in the advantage that the magnetic holding force of the magnet 231 is strengthened or focussed on the first guide part 210, since the pot-shaped area 232 causes the magnetic field, i.e. the magnetic field lines, of the magnet 231 to essentially run through the first guide part 210. The pot-shaped area 232 may also comprise a channel 232a for guiding the welding wire, which forms a portion of the channel 230a or channel 201.

The wire guide device 200 may further comprise an intermediate pipe 240. The intermediate pipe 240 is attached at one end to the second guide part 220. A wire nozzle 250 may be attached to the other end of the intermediate pipe 240. The intermediate pipe 240 and the nozzle 250 each have a channel 240a, 250a, each forming a portion of the channel 201. The intermediate pipe 240 may be formed of copper, for example. The wire nozzle 250 is provided for discharging the welding wire from the wire guide device 200. The wire nozzle 250 can be formed as a wear part, as spatter and debris from deposition welding can deposit on the wire nozzle 250 and clog it. The wire nozzle 250 may be formed to be removable from the intermediate pipe 240. The wire guide device 200 may further have an insulating part 270. The intermediate pipe 240 and/or the wire nozzle 250 may be attached to the second guide part 220 by means of the insulation part 270. The guide part 270 may comprise or be made of ceramic. The insulation part 270 serves to electrically insulate the wire nozzle 250 from the other components of the wire guide device 200, since a capacitive measurement of the distance to the workpiece 3 can be performed by means of the wire nozzle 250.

The wire guide device 200 may further comprise an adjusting device 260. The adjusting device 260 is arranged to displace one of the at least two guide parts 210, 220 relative to the other of the two guide parts 210, 220 in a plane perpendicular to the predetermined wire guide direction and/or to the longitudinal axis of the guide parts and/or perpendicular to the beam propagation direction. In FIG. 3, a displacement in the x-y plane can take place by means of the adjusting device. By means of the adjusting device 260, a fine setting of the wire guide can be provided by the guide parts 210, 220. In particular, the setting can ensure that the welding wire is always guided to the processing zone along a predetermined wire guide direction and/or concentrically to the laser beam (not shown).

The adjusting device 260 may comprise multiple parts. A first part 261 may be attached to the first guide part 210. One or multiple other parts 262, 211 may be displaced relative to first part 261 and/or relative to first guide part 210.

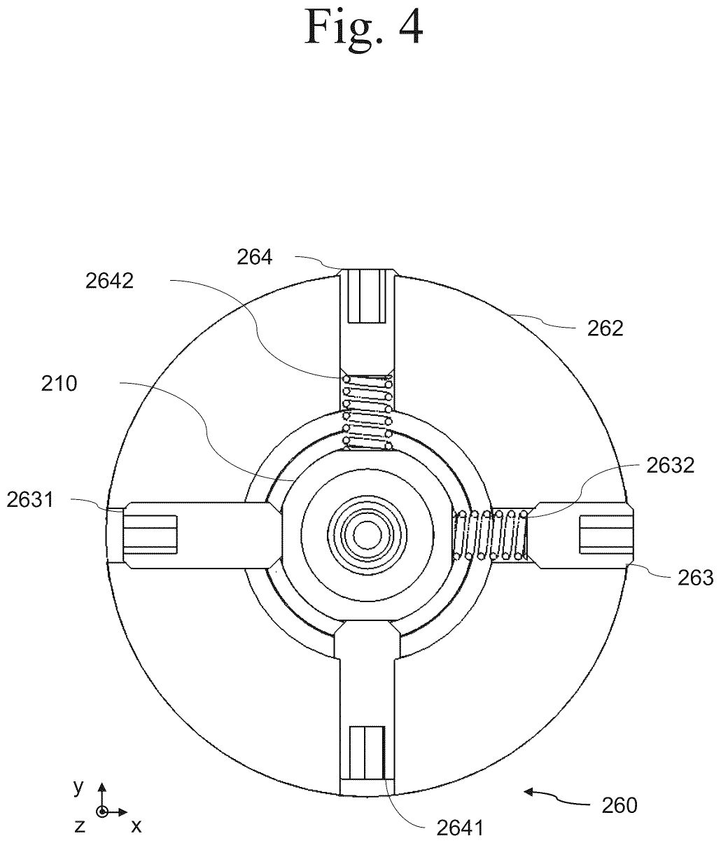

FIG. 4 shows a schematic detailed view of the adjusting device 260. FIG. 4 is a sectional view in a plane transverse to the wire guide direction, for example in the x-y plane of FIG. 3.

The adjusting device 260 comprises a first adjusting unit 263 and a second adjusting unit 264. The first adjusting unit 263 is arranged to displace the second guide part 220 relative to the first guide part 210 along a first direction, for example the x-direction in the x-y plane. The second adjusting unit 264 is arranged to displace the second guide part 220 relative to the first guide part 210 along a second direction, for example the y-direction in the x-y plane.

The first and second adjusting units 263, 264 each comprise two adjusting elements, for example bolts, grub screws or screws, 2631, 2641. These can be embedded or screwed into the second guide part 220 or a further part 262. The adjusting elements 2631, 2641 can extend in the radial direction as shown and can be in abutment on an outer side of the first guide part 210. The adjusting units 263, 264 each further have a counter element 2632, 2642, for example a compression spring, which serve to counter the adjusting elements. The counter elements 2632, 2642 can be arranged on the opposite side of the second guide part 220 or the further part 262 with respect to the longitudinal axis of the guide part 210, 220 and can also be in abutment on the outside of the first guide part 210. By turning or screwing the adjusting elements 2631, 2641, the second guide part 220 can be adjusted relative to the first guide part 210 along the respective direction. As shown, the counter elements 2632, 2642 may also have a grub screw, bolt or screw.

The outer side of the first guide part 210 may be substantially cylindrical or round at the level of the adjusting device 260. Preferably, the outer side is flattened in areas that are in abutment with the adjusting elements 2631, 2641 and/or the counter elements 2632, 2642. This provides an anti-rotation protection of the two guide parts 210, 220 relative to each other about an axis of rotation which runs parallel to the z-direction.

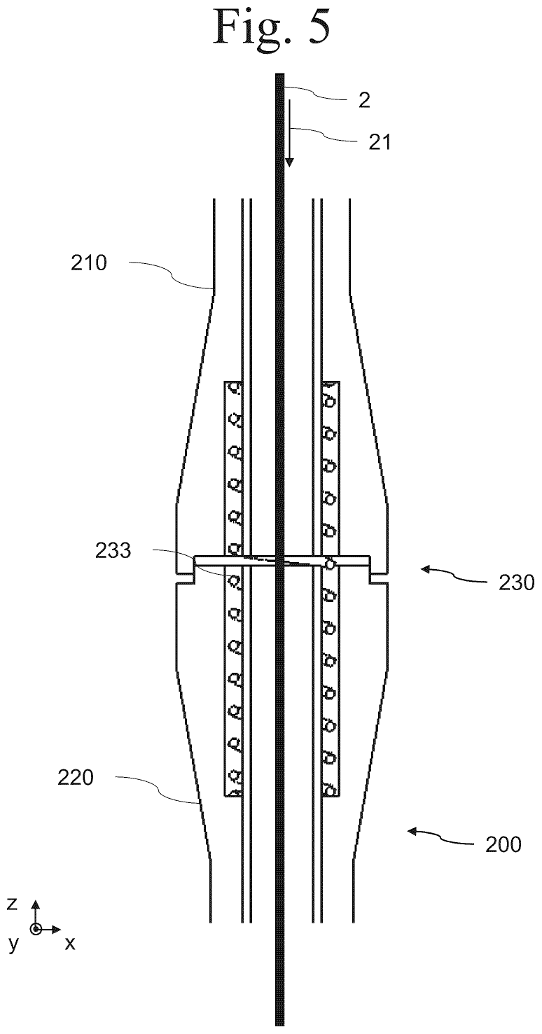

FIG. 5 shows a schematic sectional view of a wire guide device according to further embodiments of the present disclosure. The wire guide device may be, for example, the wire guide device 200 of FIGS. 1 and 2.

As shown in FIG. 5, the coupling element 230 comprises a spring 233. The spring 233 is formed as a helical spring and is connected to each of the two guide parts 210, 220. More specifically, one end of the spring 233 is connected to or embedded in the first guide part 210, and the other end of the spring 233 is connected to or embedded in the second guide part 220. The welding wire 2 can be guided through the spring 233. The spring 233 may have a spring force that is large enough to couple the guide parts 210, 220 movably and releasably to each other in the rest position. A collision of the second guide part 220 with another clement can overcome the spring force and release the two guide parts 210. 220 from each other.

1. A wire guide device for a laser processing head for deposition welding by a laser beam, the wire guide device comprising:
a plurality of guide parts arranged in succession to guide a welding wire;
wherein two of the plurality of guide parts are movably coupled to each other by a coupling element; and
wherein a second guide part of the two guide parts is displaceable and/or tiltable relative to a first guide part of the two guide parts.

2. The wire guide device according to claim 1, wherein the coupling element is arranged to movably couple the two guide parts to each other using a magnetic force and/or a spring force.

3. The wire guide device according to claim 1, wherein the coupling element comprises at least one magnet, which is attached to the second guide part and which is arranged to releasably couple the two guide parts to each other.

4. The wire guide device according to claim 3, wherein the coupling element comprises a pot-shaped area, which is attached to the second guide part and/or is formed integrally with the second guide part, and the at least one magnet is arranged in the pot-shaped area.

5. The wire guide device according to claim 3, wherein the at least one magnet is formed as a ring magnet, and/or wherein the coupling element comprises multiple magnets, which are arranged symmetrically, in particular rotationally symmetrically, with respect to a longitudinal axis of the wire guide device and/or with respect to a longitudinal axis of the second guide part.

6. The wire-guiding device according to claim 3, wherein the at least one magnet comprises samarium and/or cobalt or is formed from a samarium-cobalt alloy.

7. The wire guide device according to claim 1, wherein the coupling element comprises at least one spring, which is connected to the two guide parts and which is arranged to couple the two guide parts movably to one another.

8. The wire-guide device according to claim 7, wherein the spring is formed as a helical spring, in particular a pressure helical spring, or as a leaf spring.

9. The wire guide device according to claim 1, comprising an adjusting device arranged to displace the second guide part relative to the first guide part in a plane (x-y) perpendicular to the wire guide direction and/or to the longitudinal axis of the first guide part.

10. The wire guide device according to claim 9, wherein the adjusting device comprises:
a first adjusting unit arranged to displace the second guide part relative to the first guide part along a first direction in the plane; and
a second adjusting unit arranged to displace the second guide part relative to the first guide part along a second direction in the plane (x-y), wherein the first direction (x) and the second direction (y) are preferably perpendicular to each other.

11. The wire guide device according to claim 9, wherein the adjusting device comprises at least one screw, at least one bolt and/or at least one spring.

12. The wire guide device according to claim 1, wherein the multiple guide parts each have a channel for passing the welding wire through the respective guide part.

13. The wire guide device according to claim 1, wherein:
the first guide part is attached to or fixedly connectable to a housing of the laser processing head;
the wire guide device further comprising an intermediate pipe, which is attached at one end to the second guide part, and a wire nozzle arranged at the other end of the intermediate pipe for dispensing the welding wire from the wire guide device.

14. A laser processing head for laser deposition welding, comprising a wire guide device according to claim 1.

15. The laser processing head according to claim 14. further comprising a detection device which is arranged to detect a movement. in particular a displacement and/or tilting, of the second guide part relative to the beam propagation direction of the laser beam.
